(19) United States
(12) Patent Application Publication
(10) Pub. No.: US 2021/0001416 A1
(43) Pub. Date: Jan. 7, 2021

(54) END MILL FOR ORBITAL HOLE GENERATION WITH EDGE RELIEF

(71) Applicant: THE BOEING COMPANY, Chicago, IL (US)

(72) Inventors: Kwok Tung Chan, Seattle, WA (US); Tanni Sisco, Seattle, WA (US)

(21) Appl. No.: 16/459,025

(22) Filed: Jul. 1, 2019

(51) Int. Cl. B23C 5/20; B23C 5/12

(52) U.S. Cl. CPC B23C 5/202; B23C 5/26; B23C 5/12

(57) ABSTRACT

An example end mill includes a shaft, a cutting head positioned on one end of the shaft, and an edge relief cutting head positioned on the shaft spaced apart from the cutting head. The portion of the shaft between the cutting head and the edge relief cutting head has a diameter that is less than the diameters of the cutting head and the edge relief cutting head. The end mill is rotated around a longitudinal axis of the end mill and revolved around a central axis of a hole to be cut, with the longitudinal axis radially offset from the central axis, to cut the hole with the cutting head and cut an edge relief in a leading edge of the hole with the edge relief cutting head.

### FIELD

This disclosure relates to end mills for orbital hole generation and, more specifically, to end mills for orbital hole generation with edge relief.

### BACKGROUND

Typical end mills used for orbital hole generation in metallic materials leave a sharp edge at the leading edge of the hole generated, which can create a stress concentration point at the sharp edge. In addition, when the hole is to receive a protruding head fastener, the sharp edge interferes with the head of the fastener. Therefore, a countersink washer is required to be used over the sharp edge of the hole to receive the head of the fastener or an edge relief, such as a chamfer edge or a fillet edge, must be cut in the leading edge of the hole to receive the head of the fastener. However, use of countersink washers requires additional parts and is requires labor intensive installations. Furthermore, cutting of an edge relief currently requires a secondary operation after generation of the hole with an end mill, such as cutting the edge relief with a countersink or other cutting tool, which increases manufacturing time and cost and can be very difficult to cut accurately, especially for some metallic materials, such as titanium, which require the application of substantial pressure to cut the edge relief.

### SUMMARY

In one embodiment of the present disclosure, an example end mill comprises a shaft, a cutting head positioned on one end of the shaft, and an edge relief cutting head positioned on the shaft and spaced apart from the cutting head. A portion of the shaft between the cutting head and the edge relief cutting head has a diameter that is less than a diameter of the cutting head and less than a diameter of the edge relief cutting head.

In one embodiment, in the example end mill of the previous embodiment, the cutting head is removably secured to the shaft.

In one embodiment, in the example end mill of any of the previous embodiments, the edge relief cutting head is removably secured to the shaft.

In one embodiment, in the example end mill of any of the previous embodiments, the edge relief cutting head includes replaceable cutting inserts.

In one embodiment, in the example end mill of any of the previous embodiments, the edge relief cutting head is configured to produce one of a fillet edge or a chamfer edge.

In one embodiment, in the example end mill of any of the previous embodiments, the cutting head and the edge relief cutting head are integral and unitary with the shaft.

In another embodiment of the present disclosure, an example method comprises: rotating an end mill around a longitudinal axis of the end mill, the end mill having a shaft defining the longitudinal axis; revolving the end mill about a central axis of a hole to be cut with the longitudinal axis of the end mill parallel to and radially offset a first radial distance from the central axis of the hole; cutting the hole with a cutting head of the end mill; and cutting an edge relief in a leading edge of the hole with an edge relief cutting head of the end mill. Wherein the cutting head and the edge relief cutting head are positioned on the shaft of the end mill and spaced apart by a predetermined distance.

In one embodiment, the example method of the previous embodiment further comprises revolving the end mill about the central axis of the hole with the longitudinal axis of the end mill parallel to and radially offset a second radial distance from the central axis of the hole before cutting the edge relief in the leading edge of the hole.

In one embodiment, in the example method of any of the previous embodiments, the second radial distance is less than the first radial distance.

In one embodiment, in the example method of any of the previous embodiments, the edge relief cutting head produces one of a fillet edge or a chamfer edge.

In one embodiment, in the example method of any of the previous embodiments, the cutting head is positioned on one end of the shaft and a portion of the shaft between the cutting head and the edge relief cutting head has a diameter that is less than a diameter of the cutting head and less than a diameter of the edge relief cutting head.

In one embodiment, in the example method of any of the previous embodiments, the cutting head is removably secured to the shaft.

In one embodiment, in the example method of any of the previous embodiments, the edge relief cutting head is removably secured to the shaft.

In one embodiment, in the example method of any of the previous embodiments, the edge relief cutting head includes replaceable cutting inserts.

In one embodiment, in the example method of any of the previous embodiments, the cutting head and the edge relief cutting head are integral and unitary with the shaft.

In yet another embodiment of the present disclosure, an example method comprises: rotating an end mill around a longitudinal axis of the end mill; revolving the end mill about a central axis of a hole to be cut with the longitudinal axis of the end mill parallel to and radially offset a first radial distance from the central axis of the hole and cutting the hole with a cutting head of the end mill; and revolving the end mill about the central axis with the longitudinal axis of the end mill parallel to and radially offset a second radial distance from the central axis of the hole and cutting an edge relief in a leading edge of the hole with an edge relief cutting head of the end mill.

In one embodiment, in the example method of the previous embodiment, the second radial distance is less than the first radial distance.

In one embodiment, in the example method of any of the previous embodiments, the edge relief cutting head produces one of a fillet edge or a chamfer edge.

In one embodiment, in the example method of any of the previous embodiments, the end mill includes a shaft; the cutting head is positioned on one end of the shaft; the edge relief cutting head is positioned on the shaft and spaced apart from the cutting head; and a portion of the shaft between the cutting head and the edge relief cutting head has a diameter that is less than a diameter of the cutting head and less than a diameter of the edge relief cutting head.

In one embodiment, in the example method of any of the previous embodiments, the cutting head is removably secured to the shaft.

In one embodiment, in the example method of any of the previous embodiments, the edge relief cutting head is removably secured to the shaft.

In one embodiment, in the example method of any of the previous embodiments, the edge relief cutting head includes replaceable cutting inserts

In one embodiment, in the example method of any of the previous embodiments, the cutting head and the edge relief cutting head are integral and unitary with the shaft.

The features, functions, and advantages that have been discussed can be achieved independently in various embodiments or may be combined in yet other embodiments further details of which can be seen with reference to the following description and drawings.

### BRIEF DESCRIPTION OF DRAWINGS

FIG. 1 is a side view of an example end mill;

FIG. 2 is an exploded view of the example end mill of FIG. 1;

FIG. 3A is an illustration of the example end mill of FIG. 1 cutting a hole with a cutting head of the end mill;

FIG. 3B is an illustration of the example end mill of FIG. 3A cutting an edge relief in a leading edge of the hole with an edge relief cutting head of the end mill;

FIG. 3C is an illustration of the example end mill of FIG. 3B retracted with the hole and edge relief cut;

FIG. 4A is an illustration of another example end mill cutting a hole with a cutting head of the end mill;

FIG. 4B is an illustration of the example end mill of FIG. 4A cutting an edge relief in a leading edge of the hole with an edge relief cutting head of the end mill; and

FIG. 4C is an illustration of the example end mill of FIG. 4B retracted with the hole and edge relief cut.

### DESCRIPTION

The example end mill and example methods using an example end mill disclosed herein incorporate an edge relief cutting head on the end mill and add an edge relief cutting cycle to the orbital drilling of the hole to cut the desired edge relief in the leading edge of the hole utilizing the orbital drill stroke. Incorporating the cutting head and edge relief cutting head on the end mill and cutting the edge relief during the standard orbital drilling of the hole eliminates the sharp edge at the leading edge of the hole, which removes a possible stress concentration point, eliminates the need for additional countersink washers, which saves on part and labor costs and provides weight savings, and eliminates the need for secondary operations, which decreases manufacturing and cycle time and manufacturing costs.

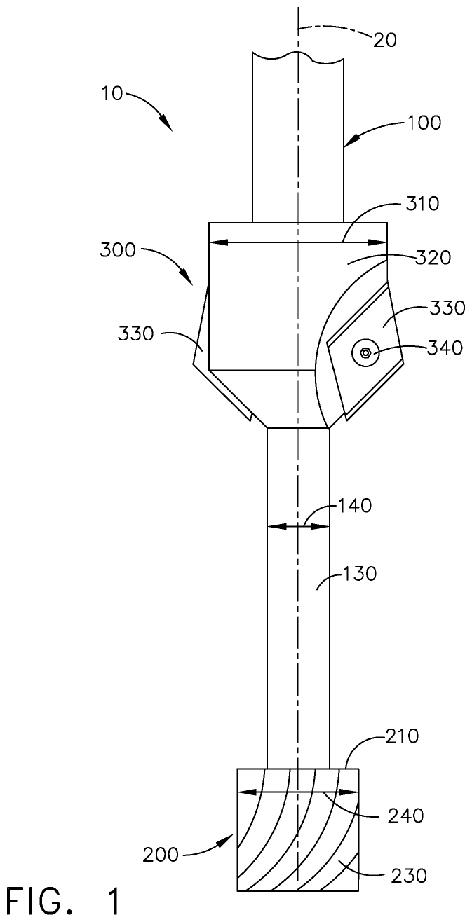

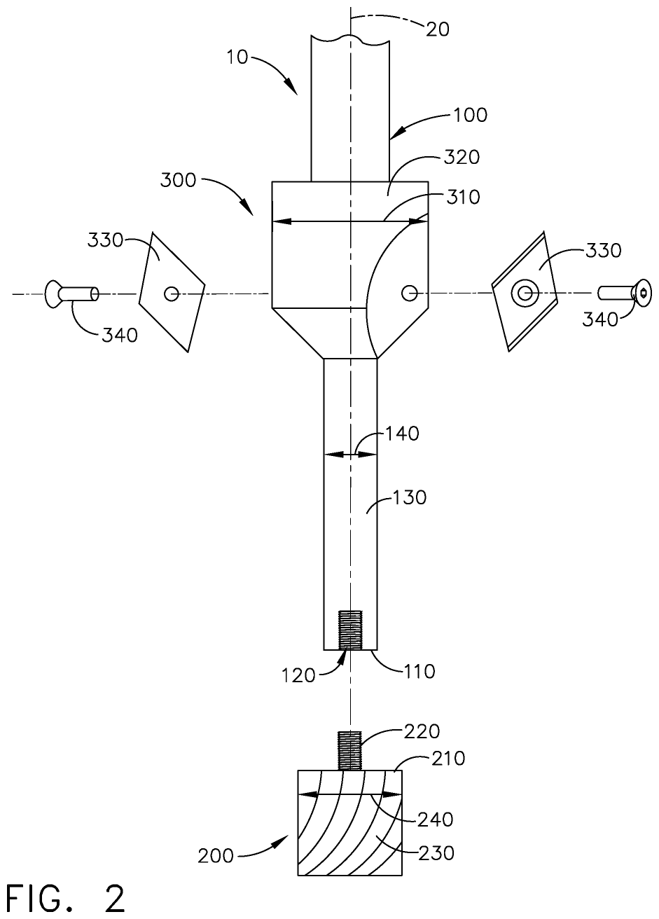

Referring to FIGS. 1 and 2, an example end mill 10 is shown that generally includes a shaft 100, a cutting head 200 positioned on or near one end 110 of shaft 100, an edge relief cutting head 300 positioned on shaft 100 and spaced apart longitudinally from cutting head 200, and a longitudinal axis 20 that is defined by shaft 100. Shaft 100 is a standard substantially cylindrical tool shaft and, in the example shown, has multiple portions that have different diameters. In various examples, shaft 100 could be any cross-sectional shape desired and, rather than changing diameter or cross-sectional dimension, could have a consistent diameter or cross-sectional dimension from one end 110 of shaft 100 to the opposite end.

In the particular example shown, cutting head 200 has a head 210 that defines the cutting surface 230 of cutting head 200 on an outer radial surface and is removably secured to shaft 100 by a threaded stem 220 that extends from head 210 and threads into a threaded aperture 120 in shaft 100. In various examples, cutting head 200 can be removably secured to shaft 100 in any other manner desired or could also be permanently secured to shaft 100, such as by welding. Alternatively, cutting head 200 and shaft 100 could also be formed together as a single, integral, unitary structure. As shown, cutting head 200 is essentially the same as the cutting head of a standard end mill, but could also be a drill bit. Preferably, the diameter 140 or outer dimension of the portion 130 of shaft adjacent cutting head 200 is smaller than the diameter 240 or outer dimension of cutting head 200 to that shaft 100 does not engage the inner surface of the hole being drilled.

Similarly, in the example shown, edge relief cutting head 300 is also removably secured to shaft 100. For example, body portion 320 of edge relief cutting head 300 could be a single, solid, unitary structure having a central aperture that slides over shaft and is secured to shaft 100 with a threaded member or other securement means. In addition, body portion 320 could be a multi-part structure that is positioned around shaft 100 and secured together with threaded members and secured to shaft 100. Body portion 320, whether a single, solid, unitary structure or a multi-part structure, could also be permanently secured to shaft 100, such as by welding. Alternatively, edge relief cutting head 300 and shaft 100 could also be formed together as a single, integral, unitary structure.

In the example shown, edge relief cutting head 300 also has removable/replaceable cutting inserts 330 to produce the edge relief that are removably secured to body portion 320 so that cutting inserts 330 can be removed and replaced when worn or different cutting inserts could be used for use on different materials (e.g., titanium or steel) or to produce different types of edge relief. For example, depending on the cutting inserts 330 used, edge relief cutting head 300 could be configured to produce a fillet edge, a chamfer edge, or any other type of edge relief desired. For example, edge relief cutting head 300 could be configured to produce a chamfer edge having an insert angle that matches a flat/flush/countersink head fastener to enable the use of the fastener on a flat or contoured surface. As shown, cutting inserts 330 are positioned in concave recesses in body portion 320 and secured to body portion 320 with threaded members 340. In various examples, cutting inserts 330 could be removably secured to body portion 320 in any manner desired, such as clips or other types of fasteners, or can be permanently secured to body portion 320, such as by welding. Alternatively, the cutting inserts and body portion could also be formed together as a single, integral, unitary structure and the type of edge produced defined by the cutting surface formed in edge relief cutting head 300. Preferably, the diameter 140 or outer dimension of the portion 130 of shaft adjacent edge relief cutting head 300 is smaller than the diameter 310 or outer dimension of edge relief cutting head 300 to that shaft 100 does not engage the inner surface of the hole when edge relief cutting head 300 is cutting the edge relief.

Edge relief cutting head 300 is spaced apart from cutting head 200 by a predetermined distance. The predetermined distance may be based on the depth of the material being cut, to allow cutting head 200 to complete the cutting of the hole through the material before edge relief cutting head 300 engages the material to cut the edge relief. In addition, as noted above, the portion 130 of shaft 100 between cutting head 200 and edge relief cutting head 300 has a diameter 140 that is less than the diameter 240 of cutting head 200 and less than the diameter 310 of edge relief cutting head 300 so that the portion 130 of shaft 100 does not engage the side walls of the hole cut by cutting head 200 when cutting head 200 cuts the hole or when edge relief cutting head 300 cuts the edge relief in the leading edge of the hole.

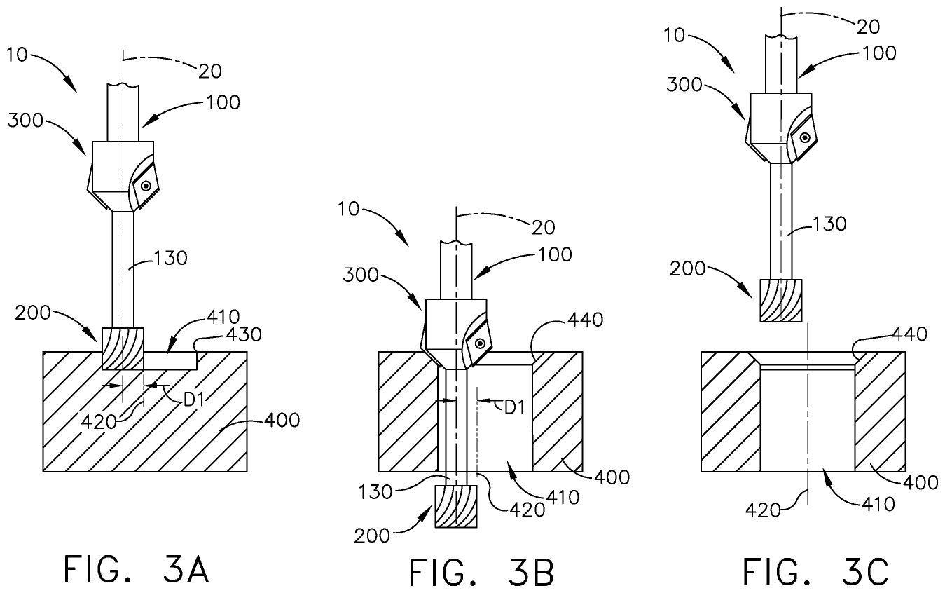

Referring to FIGS. 3A-C, one example method of generating a hole 410 in a material 400 and cutting an edge relief 440, such as a fillet edge or chamfer edge, in leading edge 430 of hole 410 is illustrated. The example shown uses end mill 10, which is rotated around longitudinal axis 20 and revolved about a central axis 420 of hole 410. As noted above, the longitudinal axis 20 is defined by the shaft 130. As discussed above, in most applications material 400 would most likely be a metallic material, such as titanium, but could be any material desired. Longitudinal axis 20 of end mill 10 is parallel to and radially offset from central axis 420 of hole 410 by a first radial distance D1 such that cutting surface 230 of cutting head 200 cuts the desired diameter of hole 410. The radius of cutting head 200 and the first radial distance D1 will determine the radius of hole 410. As shown in FIG. 3A, end mill 10 is then advanced into material 400 so that cutting head 200 cuts hole 410 in material 400.

As shown in FIG. 3B, once cutting head 200 has completed cutting hole 410 and is preferably all the way through material 400, end mill 10 is advanced further until edge relief cutting head 300 engages leading edge 430 of hole 410 to cut edge relief 440 in leading edge 430 with edge relief cutting head 300. As discussed above, depending on the configuration of edge relief cutting head 300, edge relief 440 could be a chamfer edge, a fillet edge, or any other type of edge relief desired.

As shown in FIG. 3C, once edge relief 440 has been cut in leading edge 430 of hole 410, end mill 10 is then retracted from material 400.

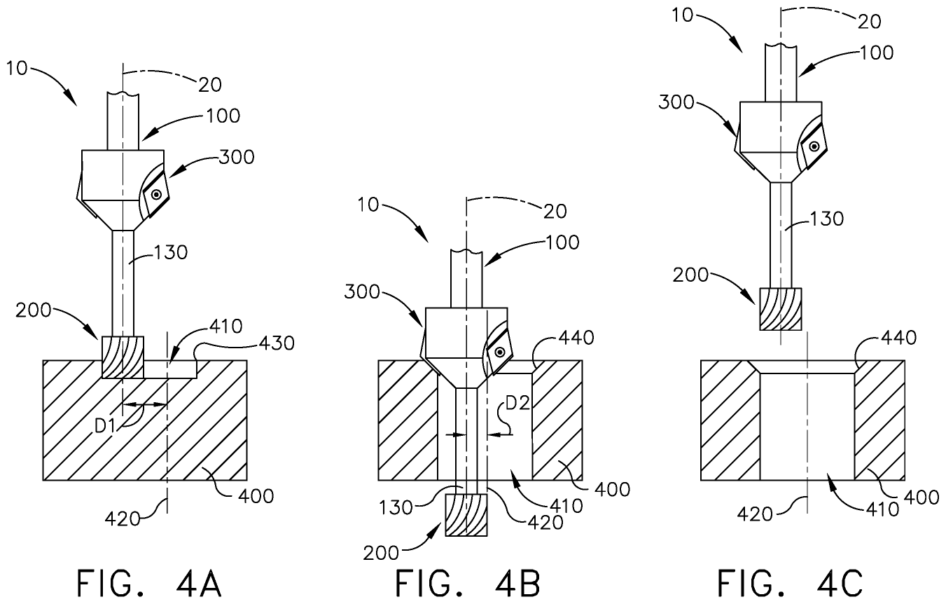

Referring to FIGS. 4A-C, another method of generating a hole 410 in a material 400 and cutting an edge relief 440, such as a fillet edge or chamfer edge, in leading edge 430 of hole 410 is illustrated. The example shown uses end mill 10, which is rotated around longitudinal axis 20 and revolved about a central axis 420 of hole 410. As discussed above, in most applications material 400 would most likely be a metallic material, such as titanium, but could be any material desired. Longitudinal axis 20 of end mill 10 is parallel to and radially offset from central axis 420 of hole 410 by a first radial distance D1 such that cutting surface 230 of cutting head 200 cuts the desired diameter of hole 410. The radius of cutting head 200 and the first radial distance D1 will determine the radius of hole 410. As shown in FIG. 4A, end mill 10 is then advanced into material 400 so that cutting head 200 cuts hole 410 in material 400.

As shown in FIG. 4B, depending on the size of edge relief cutting head 300 and the size of edge relief 440 desired, after hole 410 has been cut by cutting head 200 and cutting head 200 is preferably all the way through material 400 and before edge relief cutting head 300 engages material 400, end mill 10 can be translated radially to revolve around central axis 420 of hole 410 with longitudinal axis 20 parallel to and offset from central axis 420 by a second radial distance D2, that is different from first radial distance D1 used to cut hole 410 with cutting head 200. In the example shown, second radial distance D2 is less than first radial distance D1, however, second radial distance D1 could also be greater than first radial distance D1 depending on the size of edge relief cutting head 300 and the size and shape of edge relief 440 desired. Once end mill 10 is revolving around central axis 420 at second radial distance D2, end mill 10 is advance further until edge relief cutting head 300 engages leading edge 430 of hole 410 to cut edge relief 440 in leading edge 430 with edge relief cutting head 300. As discussed above, depending on the configuration of edge relief cutting head 300, edge relief 440 could be a chamfer edge, a fillet edge, or any other type of edge relief desired.

As shown in FIG. 4C, once edge relief 440 has been cut in leading edge 430 of hole 410, end mill 10 is then retracted from material 400.

While various embodiments have been described above, this disclosure is not intended to be limited thereto. Variations can be made to the disclosed embodiments that are still within the scope of the appended claims.

What is claimed is:

1. An end mill, comprising:
a shaft;
a cutting head positioned on one end of the shaft; and
an edge relief cutting head positioned on the shaft and spaced apart from the cutting head;
wherein a portion of the shaft between the cutting head and the edge relief cutting head has a diameter that is less than a diameter of the cutting head and less than a diameter of the edge relief cutting head.

2. The end mill of claim 1, wherein the cutting head is removably secured to the shaft.

3. The end mill of claim 1, wherein the edge relief cutting head is removably secured to the shaft.

4. The end mill of claim 1, wherein the edge relief cutting head includes replaceable cutting inserts.

5. The end mill of claim 1, wherein the edge relief cutting head is configured to produce one of a fillet edge or a chamfer edge.

6. The end mill of claim 1, wherein the cutting head and the edge relief cutting head are integral and unitary with the shaft.

7. A method, comprising:
rotating an end mill around a longitudinal axis of the end mill, the end mill having a shaft defining the longitudinal axis;
revolving the end mill about a central axis of a hole to be cut with the longitudinal axis of the end mill parallel to and radially offset a first radial distance from the central axis of the hole;
cutting the hole with a cutting head of the end mill; and
cutting an edge relief in a leading edge of the hole with an edge relief cutting head of the end mill; wherein
the cutting head and the edge relief cutting head are positioned on the shaft of the end mill and spaced apart by a predetermined distance.

8. The method of claim 7, further comprising revolving the end mill about the central axis of the hole with the longitudinal axis of the end mill parallel to and radially offset a second radial distance from the central axis of the hole before cutting the edge relief in the leading edge of the hole.

9. The method of claim 8, wherein the second radial distance is less than the first radial distance.

10. The method of claim 7, wherein the edge relief cutting head produces one of a fillet edge or a chamfer edge.

11. The method of claim 7, wherein:
the cutting head is positioned on one end of the shaft; and
a portion of the shaft between the cutting head and the edge relief cutting head has a diameter that is less than a diameter of the cutting head and less than a diameter of the edge relief cutting head.

12. The method of claim 7, wherein the cutting head is removably secured to the shaft.

13. The method of claim 7, wherein the edge relief cutting head is removably secured to the shaft.

14. The method of claim 7, wherein the edge relief cutting head includes replaceable cutting inserts.

15. The method of claim 7, wherein the cutting head and the edge relief cutting head are integral and unitary with the shaft.

16. A method, comprising:
rotating an end mill around a longitudinal axis of the end mill;
revolving the end mill about a central axis of a hole to be cut with the longitudinal axis of the end mill parallel to and radially offset a first radial distance from the central axis of the hole and cutting the hole with a cutting head of the end mill; and
revolving the end mill about the central axis with the longitudinal axis of the end mill parallel to and radially offset a second radial distance from the central axis of the hole and cutting an edge relief in a leading edge of the hole with an edge relief cutting head of the end mill.

17. The method of claim 16, wherein the second radial distance is less than the first radial distance.

18. The method of claim 16, wherein the edge relief cutting head produces one of a fillet edge or a chamfer edge.

19. The method of claim 16, wherein:
the end mill includes a shaft;
the cutting head is positioned on one end of the shaft;
the edge relief cutting head is positioned on the shaft and spaced apart from the cutting head; and
a portion of the shaft between the cutting head and the edge relief cutting head has a diameter that is less than a diameter of the cutting head and less than a diameter of the edge relief cutting head.

20. The method of claim 19, wherein the cutting head is removably secured to the shaft.

21. The method of claim 19, wherein the edge relief cutting head is removably secured to the shaft.

22. The method of claim 19, wherein the edge relief cutting head includes replaceable cutting inserts.

23. The method of claim 19, wherein the cutting head and the edge relief cutting head are integral and unitary with the shaft.
